(19) United States
(12) Patent Application Publication
(10) Pub. No.: US 2012/0226676 A1
(43) Pub. Date: Sep. 6, 2012

(54) SYSTEM AND METHODS THEREOF FOR ADAPTATION OF A FREE TEXT QUERY TO A CUSTOMIZED QUERY SET

(75) Inventors: Rami Kasterstein, Givataim (IL); Amihay Ben-David, London (GB); Joey Joseph Simhon, Ramat-Gan (IL)

(73) Assignee: DOAT MEDIA LTD., Tel Aviv (IL)

(21) Appl. No.: 13/474,404

(22) Filed: May 17, 2012

Related U.S. Application Data
(63) Continuation-in-part of application No. 13/156,999, filed on Jun. 9, 2011.
(60) Provisional application No. 61/487,831, filed on May 19, 2011.
(60) Provisional application No. 61/468,095, filed on Mar. 28, 2011.
(60) Provisional application No. 61/354,022, filed on Jun. 11, 2010.

(51) Int. Cl. G06F 17/30

(52) U.S. Cl. 707/706; 707/760; 707/E17.108; 707/E17.062

(57) ABSTRACT

A method for adaptation of a free text query to a customized query. The method comprises selecting at least one resource from a plurality of resources of information for responding to a query received from a user device; performing an analysis of the received query; performing at least one of: customizing the query to meet an input query format of a selected at least one resource, or and providing an input query that is transformed to meet an input requirement of the selected at least one resource; and sending the customized query to the selected at least one resource, wherein each of the selected at least one resource receives an appropriately customized query format.

### CROSS-REFERENCE TO RELATED APPLICATIONS

This application claims the benefit of U.S. provisional patent application No. 61/487,831 filed on May 19, 2011. This application is also a continuation-in-part of U.S. patent application Ser. No. 13/156,999 filed on Jun. 9, 2011, which claims the benefit of U.S. provisional patent application No. 61/468,095 filed on Mar. 28, 2011 and U.S. provisional patent application No. 61/354,022 filed on Jun. 11, 2010, the contents of each of the above-referenced applications are herein incorporated by reference.

### TECHNICAL FIELD

The disclosed invention generally relates to search engines, and more specifically to techniques of directing a search query to desired sources of answers and presentation of the answers on the display of a user's device.

### BACKGROUND

Web search engines are increasingly becoming the method by which users seek information on the World Wide Web (herein abbreviated WWW). As the WWW continues to grow in size, the task of finding relevant and pertinent information to a user's search query becomes increasingly complex. Not only do users expect answers to their search queries to be returned instantaneously, they also expect that the top answers returned relate specifically to what they are searching for.

Web search engines are computer programs accessible by web browsers which are designed to search the WWW and retrieve web pages that are files and documents accessible on the WWW and hosted by websites.

In general, web search engines generate large databases and indexes of websites and webpages accessible on the WWW, in a process known as web crawling. Such databases and indexes are updated frequently as websites and webpages are added, deleted, and changed very frequently on the WWW. The databases of a web search engine may include information regarding each webpage in the databases, such as the actual words on the webpage, and the index usually includes information relating to how a webpage should be classified and indexed in the databases. When a user submits a search query to a web search engine, the web search engine uses its indexing system to determine which webpages in its databases match the search query with which it was provided. The web search engine may be able to rank the webpages in its databases which most closely match the search query with which it was provided. The webpages which most closely match the search query are returned to the user and usually presented in the form of a list, also known as search results, a search results list, or even an “answer” to a user's search query.

There are two types of searching methods that can be performed by web search engines. In the first method, as implemented by search engines such as Google® and Bing, the input query is checked only against the indexes and databases maintained by the search engine. That is, a search query input to Google's search engine will be fully served by Google's databases and indexes and will not be relayed to other engines (e.g., to retrieve the result).

Web search engines such as Dogpile®, Ask.com® and Metacrawler® are meta-search engines, also known as secondary search engines, which provide a submitted search query to various other web search engines and present search results which have been aggregated from a plurality of web search engines to a user. Other types of known web search engines include vertical comparison engines as well as widget and gadget-based personal homepage dashboards. Vertical comparison engines are search engines which compare items for sale from various other websites. For example, PriceGrabber.com® and Shopzilla®.com enable a user to compare the price of a given product at multiple stores. Widget and gadget-based personal homepage dashboards enable a user to design a personalized homepage or personal web portal which may include a plurality of applications known as widgets or gadgets that can provide a user with information. Netvibes®.com, iGoogle and My Yahoo!® are all examples of widget and gadget-based personal homepage dashboards.

In either method, search engines do not adapt the input query and in most cases do not provide additional information when the query is submitted to the search engines' databases and/or index servers. Typically, a user enters a query in a free text format, and this query is processed as such. The user has the option to narrow the search to a certain category, for example, selecting one of the predefined categories provided by the search engines. For example, the user may select an “images” search engine and enter a free text query, if the user seeks to find a certain image. However, the categories are predefined and limited and are not associated with the search term.

Another disadvantage of prior art search engines is that the free text engine is adapted to web applications executed by web sites or other mobile applications available on the web. For example, providing a free text query “Barcelona business flight ticket from JFK” to a prior art search engine, would return, if any, web sites that offer discounts on flight tickets. This query cannot be processed by a web application for booking flight tickets on an airline, and thus requires the user to walk through a series of links to find a relevant airline, and then perform the booking process. Thus, the disability of prior art web search engines to adapt free text query to different information resources, limits the users' search experience.

It would be therefore advantageous to provide a solution that overcomes the limitations of existing web search engines.

### SUMMARY

Certain embodiments disclosed herein include a method for adaptation of a free text query to a customized query. The method comprises selecting at least one resource from a plurality of resources of information for responding to a query received from a user device; performing an analysis of the received query; performing at least one of customizing the query to meet an input query format of a selected at least one resource and providing an input query that is transformed to meet an input requirement of the selected at least one resource; and sending the customized query to the selected at least one resource, wherein each of the selected at least one resource receives an appropriately customized query format.

Certain embodiments disclosed herein also include a system for adapting a free text query to a customized query. The system comprises a database containing information respective of a plurality of resources of information; an interface for receiving a query from a user device; a computing unit for selecting at least one resource of the plurality of resources capable of providing information respective of the query, opening a display area on the user device containing at least one display segment and associating the at least one display segment with the at least one selected resource; query analyzer for analyzing the query and providing to the at least one selected resource at least one of a customized query and a transformed query; and an interface for sending the customized query to the at least one selected resource, wherein the at least one selected resource returns executable code respective of the customized query for execution within the associated at least one display segment.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram illustrating the operation of the system in accordance with the embodiments disclosed herein;

FIG. 2 is a display area with display segments on a display screen of a typical personal computer (PC) in accordance with one embodiment;

FIG. 3 is a display area with display segments of a mobile device in accordance with one embodiment;

FIG. 4 is a screenshot of a screen of a mobile device displaying a display area with display segments in accordance with one embodiment;

FIGS. 5A and 5B are display areas of a mobile device with a selection mini-display segment slider in accordance with one embodiment;

FIGS. 6A and 6B are screenshots of screens of a mobile device displaying a display area with a selection of mini-windows in accordance with one embodiment;

FIG. 7 is a flowchart describing the operation of the system according to one embodiment;

FIG. 8 is a diagram describing the adaptation of a free text query to a targeted query usable by a resource of information; and

FIG. 9 is a flowchart describing the adaptation of a free text query to a targeted query usable by a resource of information in accordance with certain embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

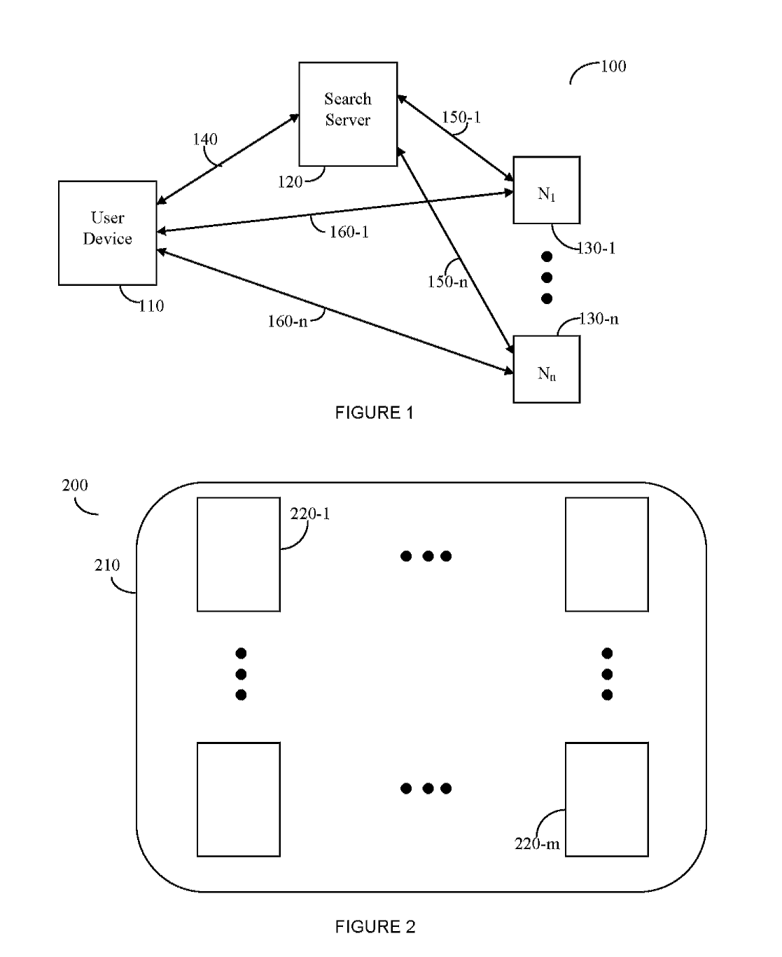

FIG. 1 depicts an exemplary and non-limiting schematic diagram 100 of a system utilized for describing certain embodiments of the invention. A user device 110 submits over communication link 140 a query to the search server 120. A query comprises search terms and in some embodiments also metadata about the user and the user device 110. Such metadata may include, but is not limited to, search history, time, device, social friends, location, and more.

The search server 120 is configured to receive the query and process it to determine which resources from a plurality of resources 130-1 through 130-n are the most appropriate to submit the query to. The resources 130 includes, but are not limited to, a plurality of web search engines, servers of content providers, vertical comparison engines, servers of content publishers, and so on. The resources 130 may be further arranged according to different categorizes.

For example, if the query term is “Hector Berlioz” then it is most likely that the best answers will be from resources that are capable of handling classical music queries. In accordance to an embodiment, the search server 120 is determines which resource would be the most appropriate resources 130 to address the query to, either by actively checking or by, for example, registration of a resource 130 to certain categories, such as “music” or “carpentry tools”, as well as, but without limitation, registration for certain keywords, Moreover, as will be described herein below, the search server 120 may monitor the use of the user on the user device 110, but not within the application in a display segment, thereby maintaining user privacy with respect to the interaction with a resource 130, to determine which of the resources was the most appropriate for the user, and thereby influencing future references to that resource.

In one embodiment of the invention, an operator is used between the search term and a metadata term, for example the operator “@”. The metadata term may be, but is not limited to, a category. A user can therefore submit a query for “Beethoven @ music” which would then be directed to, and answered by, selected resources 130 that the search server 120 determines to be capable of answering music related queries. However, the query “Beethoven @ Movies” would be directed to potentially a different group of sources from the resources 130, and one result could be the movie Beethoven with a Saint Bernard dog named Beethoven as a star of the movie. The function of this operator will be discussed in more detail herein below.

The search server 120, once one or more appropriate resources from the resources 130 have been identified, sends search requests to such selected resources 130 over communication links 150-1 through 150-n. It is not necessary to send the search requests, or a variation thereof, to all the resources 130-1 through 130-n, but only to the subgroup that is determined to be relevant for the query.

The search server 120 further provides a display area containing display segments unique for each of the resources 130 determined to be appropriate for receiving the query, and such appropriate resources are directed to communicate directly with their respective display segment on the user device over communication links 160. The display area may be an application of its own right, such as, but not limited to, a web browser.

In one embodiment, and as further explained herein below, only a portion of the selected resources of the resources 130-1 through 130-n are designated with a display segment. Selected resources that do not have an allocation of a display segment are approached when the user requests, for example, information from additional selected resources. By mere example, if there are thirty selected resources the display area may be designed to contain only ten display segments, therefore only the top ten of the selected resources are associated with a display segment. The other selected resources can be associated with the display segment upon a request for more information made by the user and as further explained below. The result is that it is not necessary for the search server 120 to have any specific information or data regarding the actual content residing on the resource unlike the prior art. The only ability needed is to determine which resource of the resources 130 is appropriate to provide a certain answer to a query and, potentially, is a resource trusted by a user of the device 110.

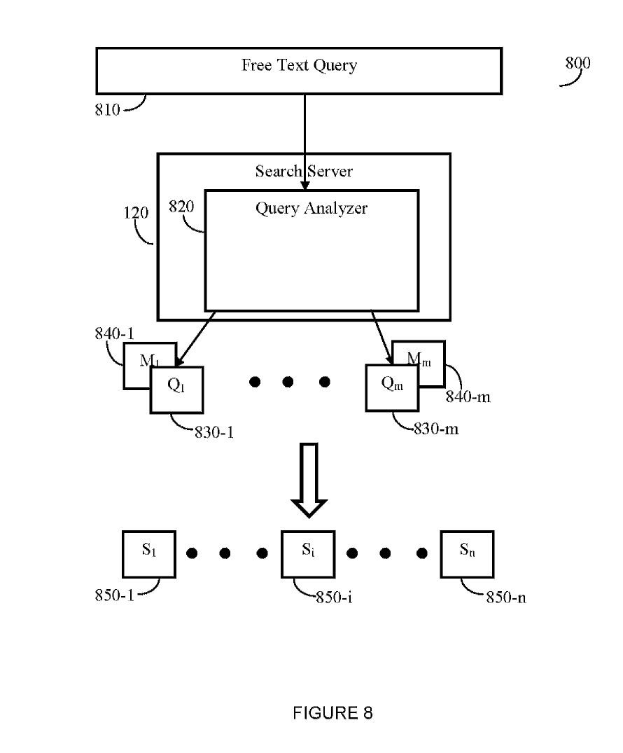

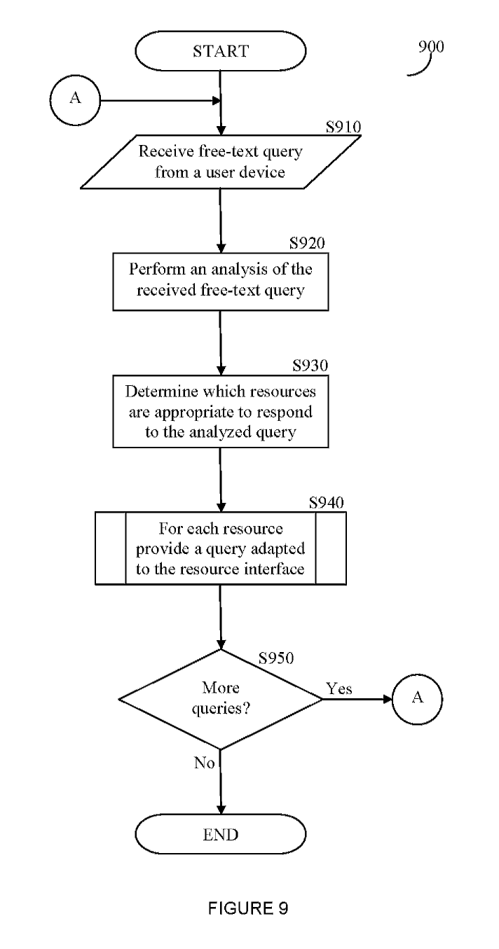

According to certain embodiments, the search server 120 provides the query, or search terms thereof, to a resource in a communication format that is proper for that specific resource thereby enabling search of such resources that require customized interface to perform any kind of successful search. The search server 120 can therefore communicate directly with a variety of resources each having its own requirement to respond to a query, and as further discussed herein below with respect to FIGS. 8 and 9. The communication links 140, 150-1, 150-n, and 160-1, 160-n may occur over a common network such as, but not limited to, a local area network (LAN), a wide area network (WAN), a metro area network (MAN), the world wide web (WWW), the Internet, a wired network, a wireless network, and the like, as well as any combination thereof.

FIG. 2 shows an exemplary and non-limiting display area 210 on a display screen 200 of a typical personal computer (PC) rendered in accordance with an embodiment the invention. It should be understood that a PC is provided here as an example, other devices having displays that are large enough to display a plurality of items large enough to be readily recognized include the like of screens of notebook computers, tablet computers, and the like. It is further understood that the display screen 200 can be an independent application or hosted and displayed in another application, such as a web browser.

The display area 210 is allocated by the search server 120 to a plurality of display areas 220, from display segment 220-1 through display segment 220-m, where n>=m. The number of display segments 220 corresponds to the number of appropriate (selected) resources 130 to which the query was referred to by the search server 120. Each display segment 220 is allocated to one of the appropriate resources 130, which provides the executable code that is to be executed within that display segment. The code includes, but is not limited to, a hyper-text markup language (HTML) code, Java scripts, code for causing an Internet mobile application installed on the user device 110 to retrieve content/information from the resource, or code returned as a result of a processing of a web application, and more, and provided by one or more of the resources 130.

In one embodiment only a portion of the selected resources of the resources 130-1 through 130-n are designated with a display segment. Those selected resources that do not have an allocation of a display segment are approached when the user requests, for example, information from additional selected resources. In yet another embodiment, a scroll function can be implemented as part of the display area 210 to enable viewing of otherwise hidden display segments. One of ordinary skill should readily realize that rather than the prior art approach of providing links in, for example, the Google® style, the response to a query, in accordance with the disclosed techniques, is one or more active applications that contain the information from appropriate resources. Such information may be stored in a memory or database (not shown) of the search server 120. It should be further noted that one display segment, e.g., segment 220-1 may contain a Google browser application, including links, as a fully functional application within a display segment 220. The advantage of the active application approach being presented to the user responsive to a query, which is operative on the user device 110, is that the server 120 does not control what is presented to the user as is done by prior art solutions, as well as having access to the application itself immediately upon delivery of the results to the query. Thus, the search server 120 can retrieve information and such information can be displayed on the user device from a plurality of action applications executed or controlled by the resources 130.

An active application as discussed herein includes, but is not limited to, a web application, and an Internet mobile application. A web application is any application that can be accessed on the WWW via a web browser. Typically, a web application is executed by a web server and the user device (client) receives the processing results, for example, a web application for booking flight tickets. An Internet mobile application, as defined herein, is any software application that can be accessed by using the Internet or via a connection to the Internet. For example, Internet mobile applications are installed on smartphones or tablet computers (Apps for Apple's iPhone® and iPAD®) are such examples of Internet applications. Typically, such applications do not require a web browser to access information and can be executed by the user device (e.g., a smartphone). Examples for Internet mobile applications include applications that play movies, applications that download songs, applications through which a user can order a pizza, applications through which a user can request an electrician to make a house call, and the like.

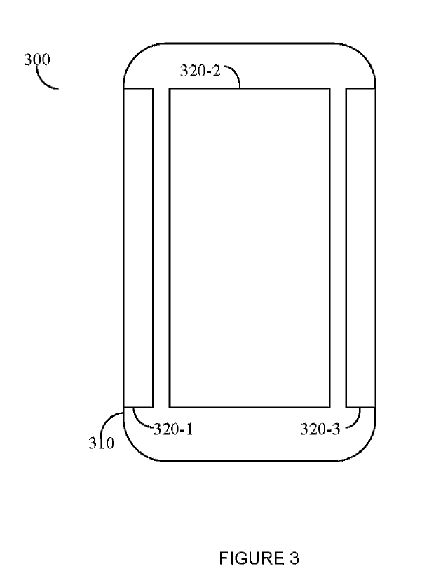

FIG. 3 shows an exemplary and non-limiting display area 310 of a mobile device screen 300 rendered in accordance with an embodiment of the invention. The mobile device (e.g., user device 110) typically has a small screen form factor, thus display techniques that differ from that shown with respect to a PC in FIG. 2 should be used. As noted above, as a result of a query entered by a user, one or more appropriate resources 130 respond with application data that is directed into corresponding display segments 320. Because of the nature of the smaller screen the center of the display area 310 is used for one display segment, for example, display segment 320-2, while from the left and the right there are other display segments, 320-1 on the left and 320-3 on the right, that can be viewed by using an appropriate gesture or other means of scrolling from left to right or right to left.

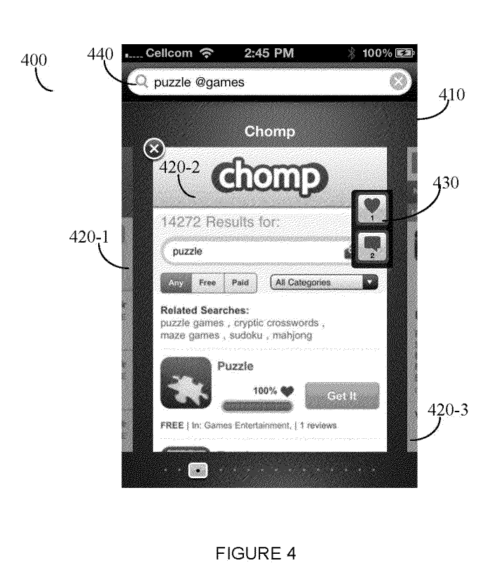

FIG. 4 shows an exemplary and non-limiting screenshot 400 of a screen of a typical mobile device displaying a display area 410 and display segments 420-1, 420-2, and 420-3, thereon, in accordance with an embodiment of the invention. In one embodiment of the invention, icons 430 may enable the user of the user device 110 to provide feedback to the search server 120 with respect to the current display segment, for example, the display segment 420-2. For example, and without limitation, an icon may allow providing a feedback that the information is useful and liked by the user, another icon may provide the opposite feedback, and so on. This feedback may be used for both determination of the relevance of the information provided by the resource responsive of the query, as well as to the user's preferences. Thus, the feedbacks provided by the users are utilized to adaptively update the selection of resources for users' queries. The user can enter a query that may contain search terms as well as metadata terms as explained hereinabove, in window 440.

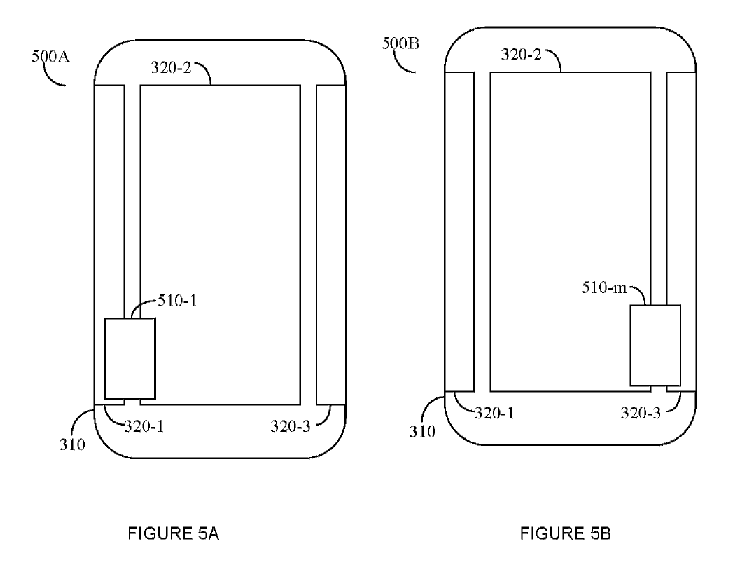

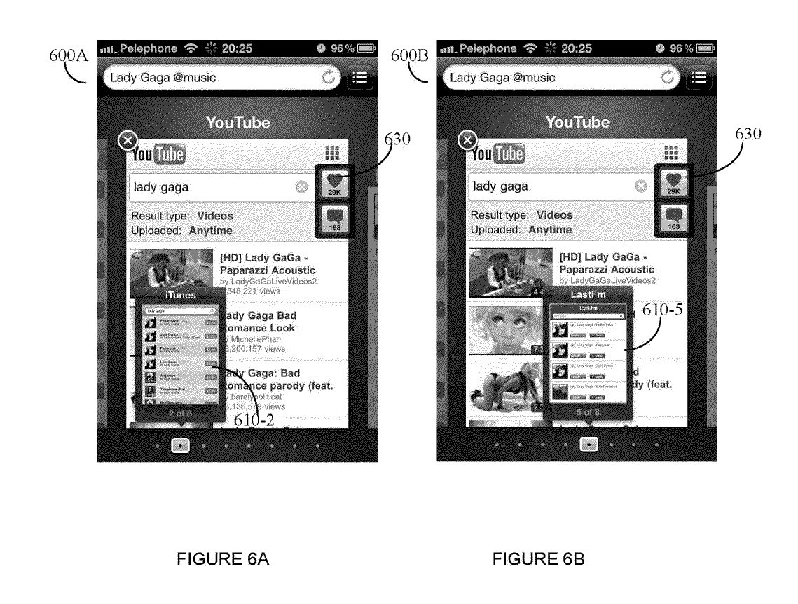

FIGS. 5A and 5B depict exemplary and non-limiting display areas 320 of a mobile device with a selection of mini-display segments 510-1 and 510-m displayed in accordance with one embodiment. In FIG. 5A, a mini-display segment 510-1 corresponds to the larger display segment 320-1 which is mostly, but for its most right portion, outside of the display area 310. The mini-display segment 510 enables the display of not currently visible display segments 320 in fully functional application form. A plurality of such mini-display segments can be shown up to the last one, for example 510-m as shown in FIG. 5B and being viewed in a slider fashion from the first to the last rolling one the display area. Corresponding non-limiting examples of screenshots 600A and 600B are shown in FIGS. 6A and 6B. The mini-display segments are labeled as “610-1” and “610-2” where icons 630 are utilize to provide the user's feedback are noted above.

In one embodiment, only a group of the selected resources of the resources 130-1 through 130-n are designated with display segments. Selected resources that do not have an allocation of a display segment are approached when the user requests, for example, information from additional selected resources. Mini-display segments 510 correspond in this case to the number of display segments made available, and additional mini-display segments 510 are added once additional information from other selected resources is requested.

In accordance with one embodiment, the display segments (shown in FIGS. 3 through 6) may include social tools for sharing the returned results with contacts stored in a social network website, such as Facebook® and/or LinkedIn®.

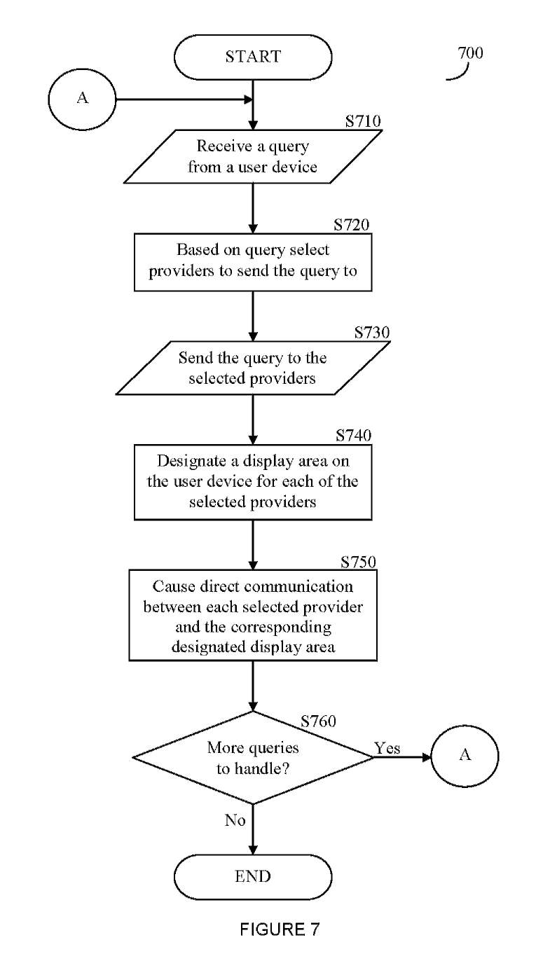

FIG. 7 shows an exemplary and non-limiting flowchart 700 describing the operation of the search server 120, according to one embodiment. In S710, the search server 120 receives a query from a user device, for example, the user device 110. In one embodiment of the invention, metadata is automatically populated and provided to the user, for example through a display of optional metadata, for better experience classification. That is, if a user searches, for example, the term Madonna, the experience classification may be for music, religion, movies and more. Such metadata may be preset in the server 120, or otherwise be constantly updated or calculated in real-time for a group of users or even on an individual basis to better fit a particular user's preferences. For example, the server 120 may determine based, in part, on search history that the user is a music fan, thus metadata related to a music classification is provided.

In yet another embodiment, the search server 120 is configured to provide metadata respective of the content provided to the resources and/or publishers, and the metadata may further include information about the geo-location of the user, so the publisher can provide location based results. For example, but without limitations, if a user is searching for Sushi, all the resources 130 may get the location of the user so they can provide restaurants and offers nearby the user's physical vicinity. As mentioned above, metadata may be entered using the operator @. For example, “Sushi @ 90210”, represents a query to search for Sushi restaurants in a location designated by the zip code “90210.” It should be appreciated that entering search queries using such notation and metadata, simplifies the process of inputting the querying and increases the chances to retrieve results for the user's satisfaction. This approach together with novel techniques for displaying the returned results, as discussed herein, enhances the users' searching experience, specifically when searching through mobile phones and/or smart phones.

In S720, based on the input query one or more resources are selected as being appropriate to provide answers respective of the received query. The selection of one or more resources 130-1 through 130-n is performed based on the input query, registration of the user to resources, and feedback provided by the user (e.g., using icons 430 and 630) when reviewing returned results. According to certain embodiments of the invention, various types of analyses can be executed on the input query.

In one type of analysis, a semantic analysis may be executed, wherein at least one action is extracted from the received query. This analysis of the received input query substantially determines what kind or type of information the user is searching for or what kind of action the user wants to execute. It is noted that the kind or type of information a user is looking for can be restated as an action which the user wishes to execute. Examples for such actions may be “comparing prices” of various items and objects, “listening” to music online or “viewing” images or video online. Thus, for example, for a query including “watching Toy Story”, where the user device is installed with a Netflix Internet mobile application, then one of the selected resources would be Netflix's servers.

In another type of analysis, a statistical analysis may be executed on the user's input query, thereby determining various statistical characteristics of the query. A statistical analysis may be executed on the user's query, thereby determining various statistical characteristics of the user's query, such as the term frequency of terms used in the user's query. Another type of analysis may include submitting the user's query to a prior art search engine, and determining a predetermined number of the top results returned from the prior art search engine. It is noted that other types of known analyses are possible in procedures for analyzing the user's query.

In S730, the query is submitted to each of the selected resources of the resources 130-1 through 130-n. In S740, the search server 120 designates a display area on the user device 110 and provides for each of the selected resources of the resources 130 a corresponding display segment, for example, a display segment 320-2. The server 120 may also provide, when applicable, one or more of the selected resources with subscription information, e.g., a user name and a password. Alternatively, the server may prompt the user to enter such information.

In S750, the server 120 causes each of the selected resources of the resources 130 to communicate directly with the user device 110 for the purpose of delivering executable code to the uniquely designated display segment 320 for that resource. This includes, but is not limited to, executable code in a hyper-text markup language (HTML) code, Java scripts, code for causing an Internet mobile application installed on the user device 110 to retrieve content/information from the resource, or code returned as a result of a processing of a web application, and more, by one or more of the resources 130.

In S760, it is checked whether additional queries are to be handled by the search server 150, and if so execution continues with S710; otherwise, execution terminates.

As noted hereinabove, the resources 130-1, 130-n may or may not be capable of receiving queries in a free-text format. While search engines provided by the like of Google and Yahoo!® are capable of receiving such free-text queries, many others will not. For example, and without limitations, a provider of information related to music may prefer to receive a query in a customized way, with dedicated fields for an artist and a song. Therefore, it is necessary to adapt a free-text query to the interface acceptable by a resource 130. For those resources that are capable to receive free-text no adaptation is necessary, however, certain metadata may be added, as noted above, or otherwise, an adaptation takes place as discussed herein.

FIG. 8 shows an exemplary and non-limiting diagram 800 describing the adaptation of a free text query to a targeted query usable by a resource of information according to an embodiment disclosed herein. A free-text query 810 is received by a query analyzer 820 from a user, for example user 110. The query analyzer 820 may be part of the search server 120 (as shown in FIG. 8). Although not shown in FIG. 8. the search server 120 also includes a database for maintaining information respective each of the resources, an interface for receiving a query from a user device, and an interface for sending queries to the selected resources a computing unit, e.g., a processor, adapted to perform the at least tasks of selecting resources and opening the display area and segments on the user device, and allocating such display segments to resources. These tasks are described in greater detail above.

The search server 120 determines a subset of resources 850-1 through 850-n from the plurality of resources 130-1, 130-n that are an appropriate target to receive the query and provides the list to the query analyzer 820. The search server 120 also provides metadata to the query analyzer 820, including but not limited to the “@ operator” metadata, that includes the categorization of the free text query 810. For example, and without limitation, if a query is for “Christmas songs lyrics,” then the search server 120 excludes music stores having Christmas sales, potentially being relevant, but not capable of providing lyrics. The query 810 is analyzed by the query analyzer 820 and transformed to search queries Q₁ 830-1 through Qₘ 830-m and corresponding metadata M₁ 840-1 through Mₘ 840-m, where it is to be understood that a metadata container may be empty. That may happen when a customized query makes no use of a metadata. The metadata may be provided by the server 120, retrieved from a database, or extracted from the original query itself.

For example, and without limitation, if the query 810 is “Madonna Like a Virgin lyrics” then the query analyzer 820 will determine that “Madonna” is associated with the category Artist, and “Like a Virgin” is in the category of Song. Therefore, resources determined to be capable of receiving customized queries having a category Artist and a category Song can now be searched by providing the search terms in the appropriate fields. The term lyrics may be a search term in some cases, a metadata in other cases, and in yet other cases may be completely dropped. The latter can happen when the query is submitted to an information source which only provides lyrics of songs. For such a source of information the use of the term “lyrics” is unnecessary because that may be all that it does, i.e., it may have fields corresponding to the artist and to the song, but not for a metadata or search term such as “lyrics” which will not even be understood. Hence, one information resource, for example 850-1 receives the query as is, another resource, for example 850-2 receives the query in a customized manner including a metadata of “lyrics”, while yet another resource of information, for example 850-3 receives only a query that may be comprised of the terms: <artist: Madonna><Song: Like a Virgin>.

Hence, it should be understood that there are several applicable options. A first option is just to transfer the query as received from the user device, with or without additional metadata. A second option is to add or remove certain terms from the free text query. For instance, in the cases discussed above, a resource providing answers to searches of lyrics does not need to have the word “lyrics” in the query itself. Again, such a customized query may be delivered to a resource 850-i with or without associated metadata. In a third option, a query is structured to address the specific delivery needs of a resource 850 for receiving a query in a predefined format. Again, such a customized query may be delivered to a resource 850-i with or without associated metadata. It should be further noted that not providing metadata may in fact be implemented as providing an empty metadata field. Furthermore, the metadata may or may not be categorizations or experiences that follow the @ operator as explained in more detail hereinabove.

To further understand the capabilities shown by the search server 120, one may consider the following non-limiting example. A free text search may look like this: “Barcelona business flight ticket from JFK”. While the free text search is quite understood, a web site of an airline may not have the capability of free text search and rather requires a customized presentation of the search terms. Hence, the query may be broken down for the airline into several search elements: <from: JFK><to: Barcelona><ticket: business_class>. The free text search can now be presented to any of the airlines that may be relevant for the search.

In accordance with the teachings disclosed herein, the actual web site (e.g., an airline) is available for access to the user of the device, thereby avoiding the need to walk through series of links as provided by conventional search solutions. Specifically, such web sites execute web applications for booking airline tickets, thus the returned results are the processing results of a web application executed by the resource (e.g., an airline web site). Typically, the customized search may also include metadata that is provided to the information resource.

FIG. 9 depicts an exemplary and non-limiting flowchart 900 describing the adaptation of a free text query to a targeted query usable by a resource of information in accordance with an embodiment of the invention. In S910, a free-text query is received from a user device, for example, the user device 110.

In S920, an analysis of the received query is performed. Such an analysis includes, but is not limited to, determination of one or more categories to which such a query pertains to as indicated by, e.g., the operator @ and the extraction of terms from the free-text query that apply to specific fields of resources, such as resources 850 that are able to receive queries only in a customized manner. The determination may be also based on the statistical analysis and semantic analysis described in detail above.

In S930, a list of resources 850 from the plurality of resources 130-1,130-n is determined to be relevant for the received query, the list typically being determined by the search server 120 and the specific information resources 850 receiving their tailored query as explained in more detail herein above. In S940, the determined resources 850 receive the query either in the original format, if they are configured to receive free-text queries, or otherwise in a customized manner, where the search terms are provided according to the defined interface of the respective resource, which may include, but not limited to, replacing the received query with a different query based on the analysis of the received query. This is performed on a per resource basis, thus a resource 850-1 may receive the same query in one format, while a resource 850-i may receive the query in a different customized format appropriate to its own interface requirements. In S950, it is checked whether additional queries are to be handled, and if so execution continues with S910; otherwise, execution terminates.

The various embodiments of the invention may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate graphical user interface of an internet mobile application, either generic or tailored for the purposes described in detail hereinabove.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for adaptation of a free text query to a customized query, comprising:
selecting at least one resource from a plurality of resources of information for responding to a query received from a user device;
performing an analysis of the received query;
performing at least one of customizing the query to meet an input query format of a selected at least one resource and providing an input query that is transformed to meet an input requirement of the selected at least one resource; and
sending the customized query to the selected at least one resource, wherein each of the selected at least one resource receives an appropriately customized query format.

2. The method of claim 1, wherein customizing the query further comprises: customization based, in part, on at least a characteristic of the selected at least one resource.

3. The method of claim 1, wherein customizing the query further comprises customization based, in part, on the analysis of the received query.

4. The method of claim 1, wherein performing the query analysis further comprises at least one of:
determining a category of at least one search term within the query, determining characteristics of the query using a statistical analysis, and determining an action associated with at least one search term within the query using a semantic analysis.

5. The method of claim 3, wherein performing the query analysis further comprises:
adding at least a metadata term to the query.

6. The method of claim 5, wherein the query further comprises an operator followed by the at least metadata term.

7. The method of claim 6, wherein the at least metadata term is used to determine, using the operator, a category to which the query pertains.

8. The method of claim 5, further comprises:
receiving at least a portion of the at least metadata term from the user device.

9. The method of claim 5, wherein adding the at least metadata term, comprising:
providing the at least metadata term respective of an experience classification.

10. The method of claim 1, wherein the customized query is any one of: a customized free text query and a structured query.

11. The method of claim 10, wherein the structured query comprises at least a field that contains a term that is provided to a corresponding field of the at least one selected resource.

12. The method of claim 1, wherein the user device is any one of: a personal computer (PC), a notebook computer, a tablet computer, a smart phone, and a mobile device.

13. The method of claim 1, wherein the plurality of resources include at least web search engines, vertical comparison engines, servers of content providers, and servers of content publishers.

14. A non-transitory computer readable medium having stored thereon instructions for causing one or more processing units to execute the method according to claim 1.

15. A system for adapting a free text query to a customized query, comprising:
a database containing information respective of a plurality of resources of information;
an interface for receiving a query from a user device;
a computing unit for selecting at least one resource of the plurality of resources capable of providing information respective of the query, opening a display area on the user device containing at least one display segment and associating the at least one display segment with the at least one selected resource;
a query analyzer for analyzing the query and providing to the at least one selected resource at least one of a customized query and a transformed query; and
an interface for sending the customized query to the at least one selected resource, wherein the at least one selected resource returns executable code respective of the customized query for execution within the associated at least one display segment.

16. The system of claim 15, wherein the query analyzer is further configured to perform at least one of: determinate of a category of at least one search term within the query, determinate of characteristics of the query using a statistical analysis, and determinate of an action associated with at least one search term within the query using a semantic analysis.

17. The system of claim 16, wherein the query analyzer is further configured to add of at least a metadata term to the customized query by the query analyzer.

18. The system of claim 17, wherein the query further includes an operator followed by the at least metadata term.

19. The system of claim 18, wherein the at least metadata term is used to determine, using the operator, a category to which the query pertains.

20. The system of claim 17, wherein at least a portion of the at least metadata term is received from the user device.

21. The system of claim 17, wherein the query analyzer provides at least a metadata term respective of an experience classification.

22. The system of claim 15, wherein the customized query is any one of: a customized free text query and a structured query.

23. The system of claim 22, wherein the structured query comprises at least a field that contains a term that is provided to a corresponding field of the at least one selected resource.

24. The system of claim 15, wherein the user device is any one of: a personal computer (PC), a notebook computer, a tablet computer, a smart phone, and a mobile device.

25. The system of claim 15, wherein the plurality of resources include at least web search engines, vertical comparison engines, servers of content providers, and servers of content publishers.

26. The system of claim 25, wherein the executable code causes to at least one of: the activation of the internet mobile applications, rendering of a search result web page as generated by a web search engine, and rendering of a webpage results from processing performed by a web application.
